(19) United States
(12) Patent Application Publication
(10) Pub. No.: US 2011/0298225 A1
(43) Pub. Date: Dec. 8, 2011

(54) Auto Lock

(76) Inventors: Luke Liang, South Plainfield, NJ (US); David Chen, Guangzhou (CN)

(21) Appl. No.: 12/792,972

(22) Filed: Jun. 3, 2010

(51) Int. Cl. E05C 1/10; E05B 15/02

(52) U.S. Cl. 292/175; 292/138; 292/164; 292/145

(57) ABSTRACT

The present invention addresses the need of the industry for a simple and comfortable latch mechanism that automatically latches a window when the window is returned to a closed position. A latch mechanism for a window includes a housing defining an opening therein, a latch bolt slidably disposed in the housing and selectively positionable between an extended position and a retracted position wherein such latch bolt is adapted to be actuated by an actuating mechanism from the retracted position to the extended position, and a stopping mechanism adapted to automatically engaged and retain the latch bolt in the retracted position as the latch bolt is positioned from the extended to the retracted position.

### TECHNICAL FIELD

The present invention relates to windows, and more specifically, to latching mechanisms for windows.

### BACKGROUND OF INVENTION

Double hung and other sliding sash type windows are very common. Typically, a latch or locking mechanism is used to secure the sashes in place to inhibit unintentional opening of the sashes and unauthorized entry to the structure.

One very common mechanism used to lock sashes together is the so-called check rail lock, which includes a sweep cam attached to a rotatable handle. The check rail lock is mounted on one of the sashes, usually the lower sash of a double-hung window proximate the center of the sash rail. A keeper structure is mounted on the other sash proximate the check rail lock. As the handle is rotated in either direction, the sweep cam is rotated into or out of engagement with the keeper in order to enable locking or opening of the window as desired. A drawback of these devices, however, is that the handle can be rotated so that the sweep cam is extended even when the sash is open. When the sash is closed with the sweep cam in such position, the extended position of the sweep cam prevents full closure of the sash. The operator of the window may not notice the window is not fully closed and latched. In addition, the sweep cam may strike and damage the other sash.

Another prior mechanism includes a sliding latch bolt that may be mounted on one sash and that is selectively engageable with a keeper mounted on the other sash. A drawback with these mechanisms, however, is often that the bolt must be held in a retracted position as the window is operated. In other case, where a mechanism for holding the bolt in a retracted position is employed, the bolt either releases as soon as the window is raised, or must be manually released with a separate catch or button. In such cases, the window may fail to close fully and may not be noticed by the operator of the window.

Some prior mechanisms have tried to solve the above problems, but the solutions are relatively complicated for manufacturers and customers. What is still needed is a more simple and comfortable latch mechanism for a window that automatically latches when the window is returned to a closed position.

### SUMMARY OF THE INVENTION

The present invention addresses the need of the industry for a simple and comfortable latch mechanism that automatically latches a window when the window is returned to a closed position. According to an embodiment of the invention, a window is equipped with a latch mechanism having a latch bolt and a spring driven actuating mechanism in the housing of the latch mechanism. The latch mechanism is mounted on a sash of a window assembly opposite a keeper or similar latch bolt receiving structure. With the window in a closed position, the latch bolt of the latch mechanism is received in the keeper to latch the sashes together, and the actuating mechanism is confined in a retracted position by the keeper. To open the window, the latch mechanism is disengaged from the keeper by grasping a finger grip on a trigger cap and pulling outwardly away from keeper. The latch bolt slides out of the keeper and goes into the housing, and the actuating mechanism is released by the keeper and extends outwardly from the housing and reaches an extended position. The latch bolt is held in a retracted position by a stopping mechanism in the housing of the latch mechanism. With the latch bolt in this position, the sash may be moved to open the window. To close the window, the sash with the latch mechanism is moved toward the keeper. The outwardly extending portion of the actuating mechanism contacts the keeper that pushes the actuating mechanism inwardly into the housing. The actuating mechanism actuates the latch bolt and disengages the latch bolt from the stopping mechanism. A spring urges the latch bolt forwardly so that it is once again engaged in the keeper and the sashes are latched together as before. According to one embodiment, when latch bolt is in the retracted position, it can also be disengaged from the holding mechanism by pushing the finger grip toward the extended position of the latch bolt. The finger grip can move along a curved track on the curved upper surface of the housing.

According to one embodiment, a latch mechanism for a window includes a housing defining an opening therein, a latch bolt slidably disposed in the housing and selectively positionable between an extended position and a retracted position wherein such latch bolt is adapted to be actuated by an actuating mechanism from the retracted position to the extended position, and a stopping mechanism adapted to automatically engaged and retain the latch bolt in the retracted position as the latch bolt is positioned from the extended to the retracted position. There is a sliding ridge on the inside surface of the housing, and the sliding ridge defines the moving track of a sliding contactor on an actuating mechanism. The actuating mechanism includes a contacting pin adapted to slide along a closed curve defined by the sliding ridge, wherein the actuating mechanism is arranged to extend outwardly from the housing without actuating the latch bolt as the contacting pin goes along one section of the closed curve, and to retract inwardly to the housing and actuate the latch bolt as the contracting pin goes along the other section of the closed curve.

Embodiments of the housing of the latch mechanism may include a top cover and a bottom cover. A hook mechanism and a plug-socket mechanism are coupled with the top cover and the bottom cover. The top and the bottom covers can be held together in two steps. The first step is that the plug-socket mechanism holds the top cover and the bottom cover together when the hook mechanism does not hold the top cover and the bottom cover. The second step is that the hook mechanism holds the top cover and the bottom cover together with the plug-socket mechanism.

The advantage of this invention is a simple and comfortable solution for manufacturers and consumers to manufacture, assemble, install, and use an automatic latch for a window.

### BRIEF DESCRIPTION OF THE DRAWINGS

FIG. 1 is one exemplary embodiment of this invention.

FIG. 2 is a top exploded view of the exemplary embodiment in FIG. 1.

FIG. 3 is a bottom exploded view of the exemplary embodiment in FIG. 1.

FIG. 4 is a detailed view of the actuator in FIG. 1.

FIG. 5 is a detailed view of the base cover in FIG. 1.

FIG. 6 is a detailed bottom view of the latch bolt in FIG. 1.

FIG. 7 is a detailed top view of the latch bolt in FIG. 1.

FIG. 8 is one exemplary assembly process of the latch mechanism in FIG. 1.

FIG. 9 A-D show a detailed process of assembling a latch bolt into a base cover.

FIG. 10 A-B show a detailed process of mounting the assembled top cover to the assembled base cover.

FIG. 11 shows the sliding track of the trigger cap on the arc side of the top cover.

FIG. 12 A-C show detailed connection between the trigger cap and the latch bolt in the locked position and unlocked position of the latch mechanism.

FIG. 13 A-D show an acting process of a latch mechanism.

FIG. 14 A-E show a detailed actuating process of a latch mechanism.

FIG. 15 A-J show different embodiments with various trigger caps and screw holes.

### DETAILED DESCRIPTION OF THE INVENTION

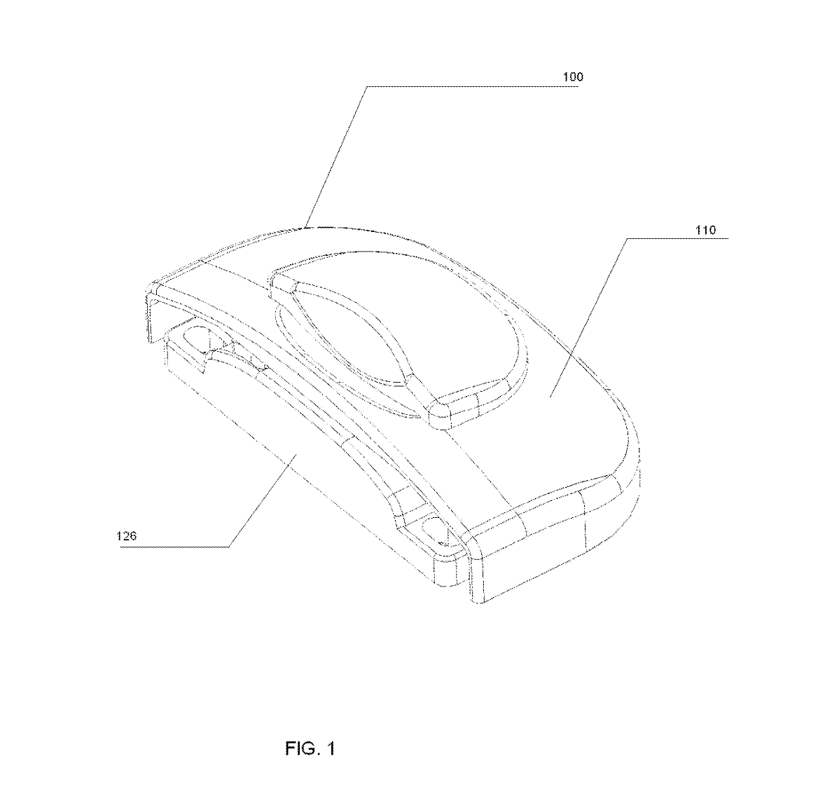

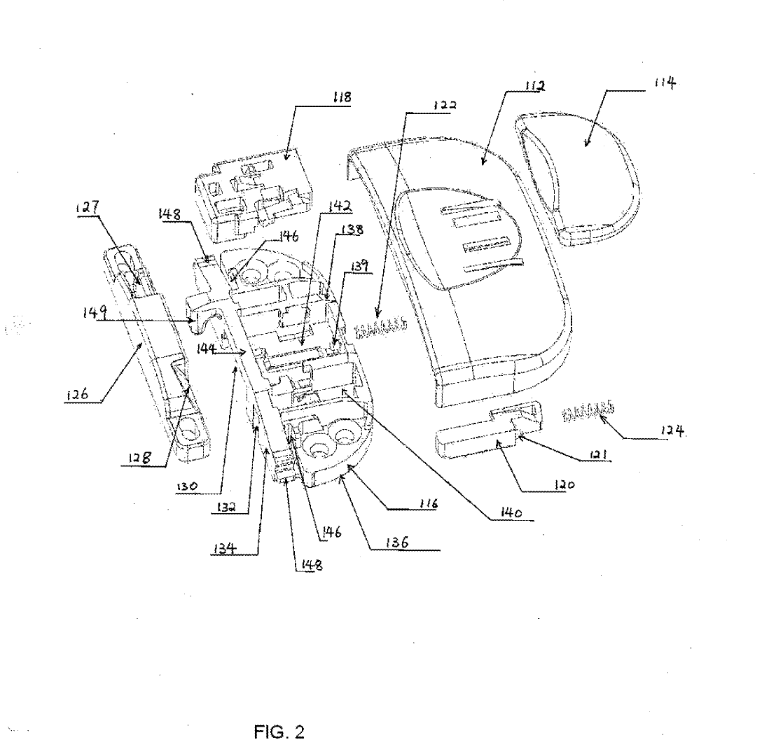

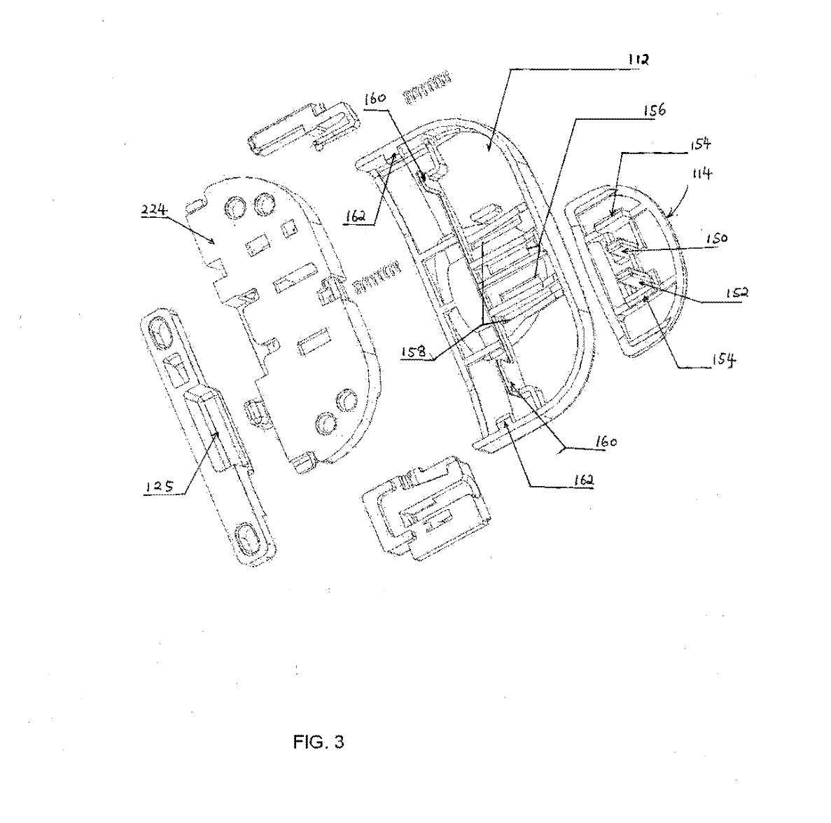

FIG. 1 is one exemplary embodiment of this invention. FIG. 2 is a top exploded view of the exemplary embodiment in FIG. 1. Latch mechanism 100 generally includes housing 110 (shown in FIG. 1), latch bolt 118, trigger cap 114, one resilient element that can be base spring 122, actuator 120, and another resilient element that can be actuator spring 124. Latch mechanism 100 and latch keeper 126 together constitute a lock mechanism 99 (shown in FIG. 1). Those skilled in the art will realize and understand, upon reading this description, that other and or different resilient elements may be used to fulfill the same function. Housing 110 generally includes top cover 112 and base cover 116. Base cover 116 generally includes front wall 134, rear wall 138, and bottom wall 136. Front wall 134 and bottom wall 136 together define openings known as latch bolt aperture 130 and actuator aperture 132. Rear wall 138 includes base spring post 139. Base cover 116 further has actuator guide slot 140, latch bolt guide slot 142, and latch bolt aperture beam 144. Actuator guide slot 140 and latch bolt guide slot 142 extend from front wall 134 to rear wall 138. Latch keeper 126 generally includes latch keeper socket 127, keeper bevel wall 128, and latch bolt receiver 125 (shown in FIG. 3).

FIG. 3 is a bottom exploded view of the exemplary embodiment in FIG. 1. Trigger cap 114 generally includes short cap shaft 150, long cap shaft 152, and a pair of cap hooks 154. Top cover 112 generally includes a pair of top cover slots 156, a pair of cap hook guide slots 158, a pair of upper plugs 160, and a pair of upper hooks 162.

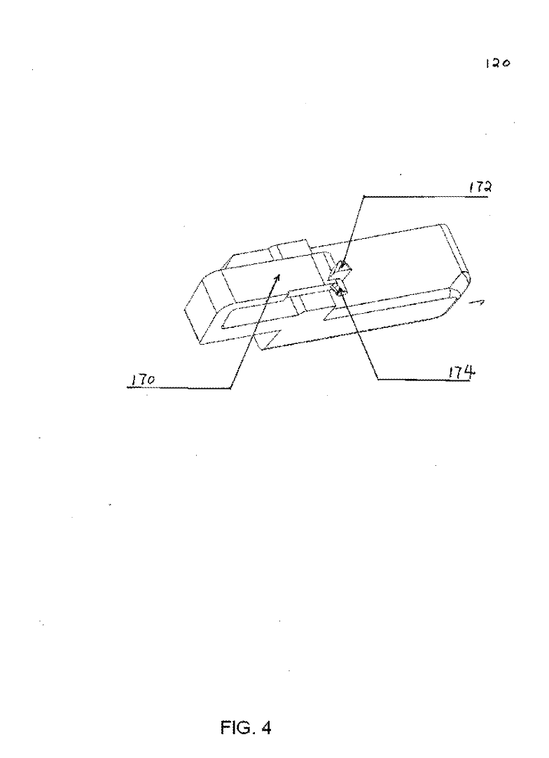

FIG. 4 is a detailed view of actuator 120 in FIG. 1. Actuator 120 generally includes actuator spring post 121 (shown in FIG. 3), actuator arm 170, actuating pin 172, and a sliding contactor known as contacting pin 174. Those skilled in the art will realize and understand, upon reading this description, that other and or different sliding contactors may be used to fulfill the same function.

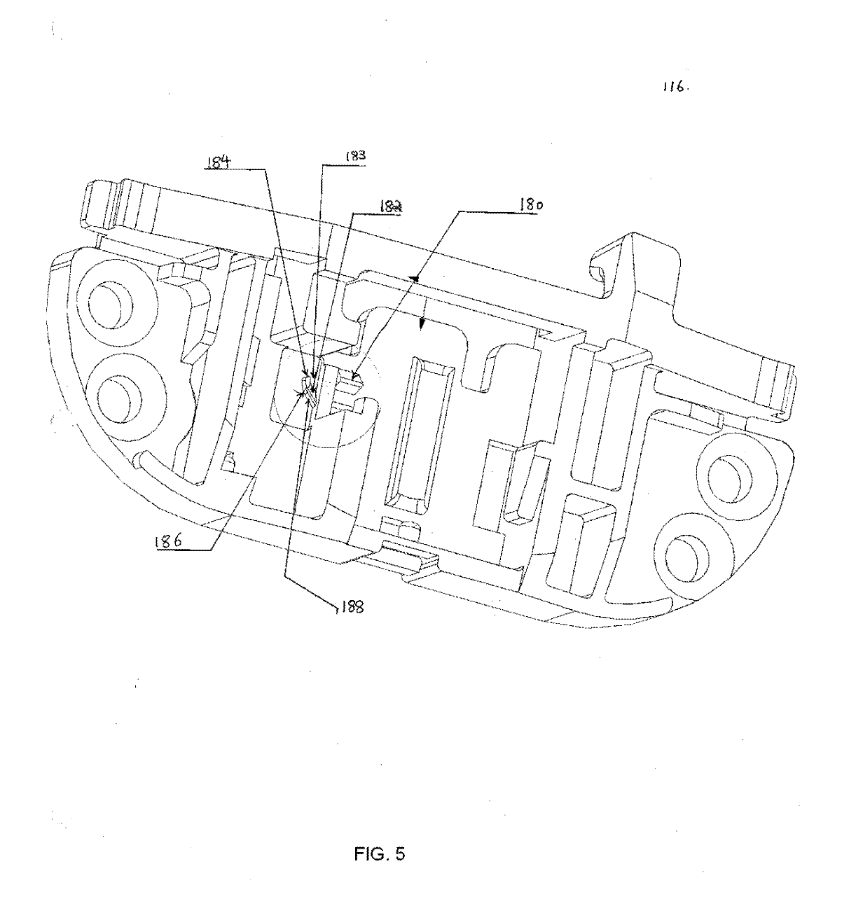

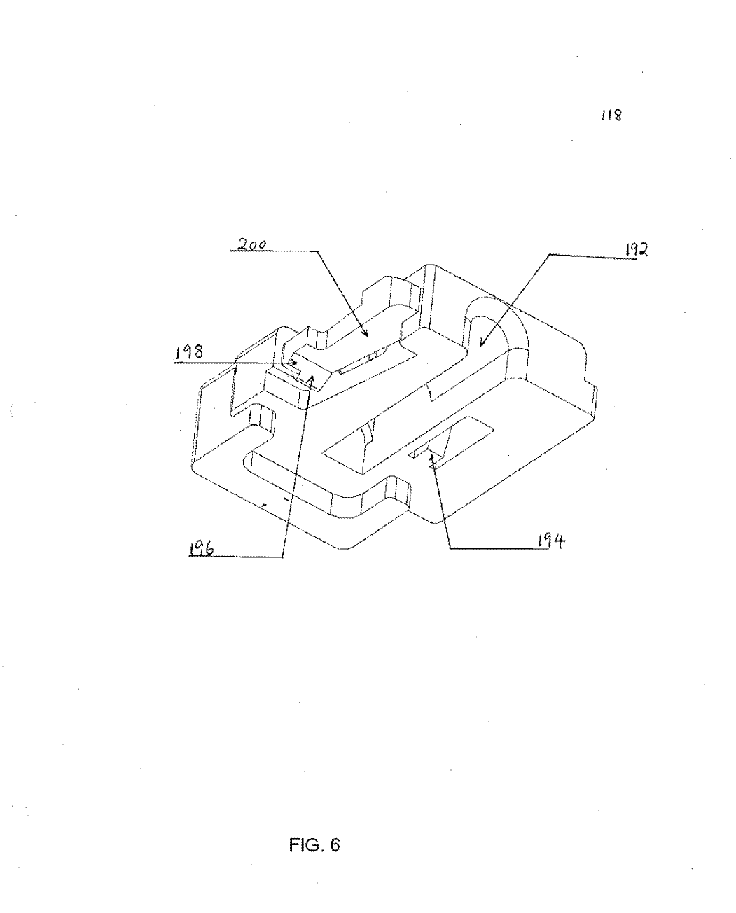

FIG. 5 is a detailed view of base cover 116. Base cover 116 further includes base stopping pin 180, base chamfer 182, harbor area 183, base stud 184, base arc side 186, and base limit wall 188. Base stopping pin 180 and latch stopping pin 196 (shown in FIG. 6) constitute a stopping mechanism. Those skilled in the art will realize and understand, upon reading this description, that other and or different stopping mechanisms may be used to fulfill the same function.

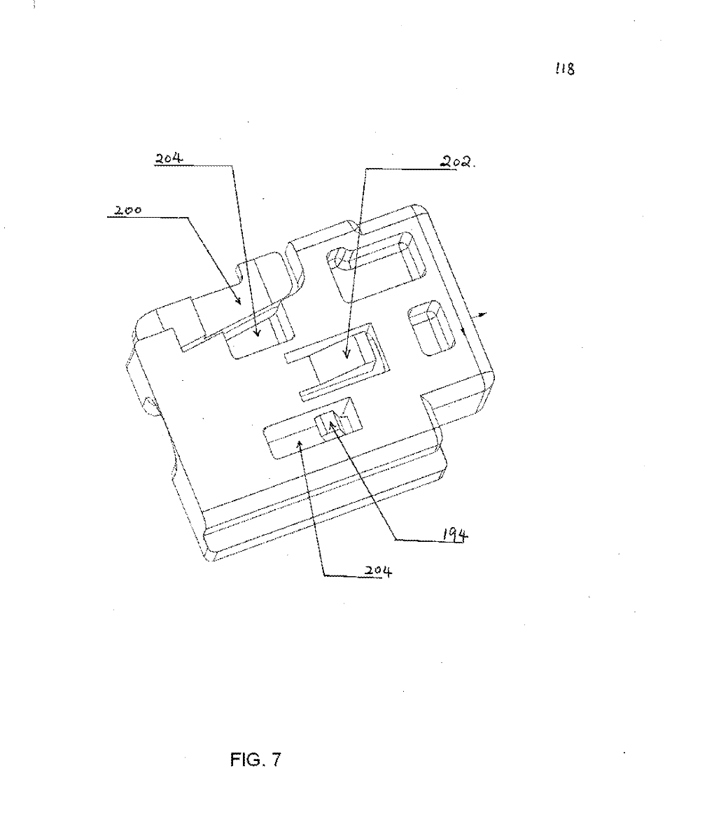

FIG. 6 is a detailed bottom view of latch bolt 118. Latch bolt 118 generally includes base spring slot 192, flexible tab 194, latch stopping pin 196, latch trigger pin 198, and latch bolt arm 200. FIG. 7 is a detailed top view of latch bolt 118. Latch bolt 118 further includes a confining element and a pair of latch bolt slots 204. One embodiment of the confining element can be latch assembly limit 202.

In addition, those skilled in the art will realize and understand, upon reading this description, that other and or different architectures may be used to build this invention.

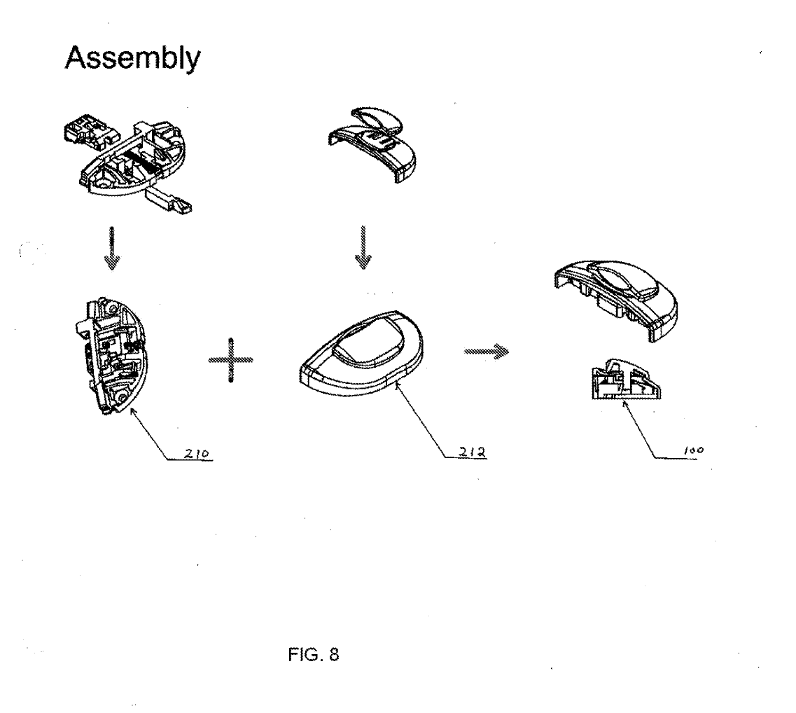

One exemplary assembly process is shown in FIG. 8. The exemplary assembly process generally includes the flowing steps. Base spring 122 is mounted on base spring post 139. Latch bolt 118 is positioned through latch bolt aperture 130 into latch bolt guide slot 142, wherein base spring 122 fits into base spring slot 192. Actuator spring 124 is mounted in the actuator guide slot 140. Actuator 120 is positioned into actuator guide slot 140 with actuator spring post 121 fitting into actuator spring 124 and with actuator 120 extending from actuator aperture 132. These steps lead to assembled base cover 210 (shown in FIG. 8).

Trigger cap 114 is slidably disposed on top cover 112 with short cap shaft 150 and long cap shaft 152 extending through each of top cover slots 156 and with each of cap hooks 154 extending through a separate one of cap hook guide slots 158. These steps lead to assembled top cover 212 (shown in FIG. 8).

Assembled top cover 212 is mounted on assembled base cover 210 with short cap shaft 150 and long cap shaft 152 fitting into a separate one of latch bolt slots 204, with each one of upper plugs 160 fitting into a separate one of bottom slots 146, and with each one of upper hooks 162 snapping on a separate one of bottom hooks 148. These steps lead to latch mechanism 100. The upper hooks 162 and the bottom hooks 148 constitute a hook mechanism. The upper plugs 160 and the bottom slots 146 constitute a plug-socket mechanism. Those skilled in the art will realize and understand, upon reading this description, that other and or different hook mechanisms and plug-socket mechanisms may be used to fulfill this assembling process.

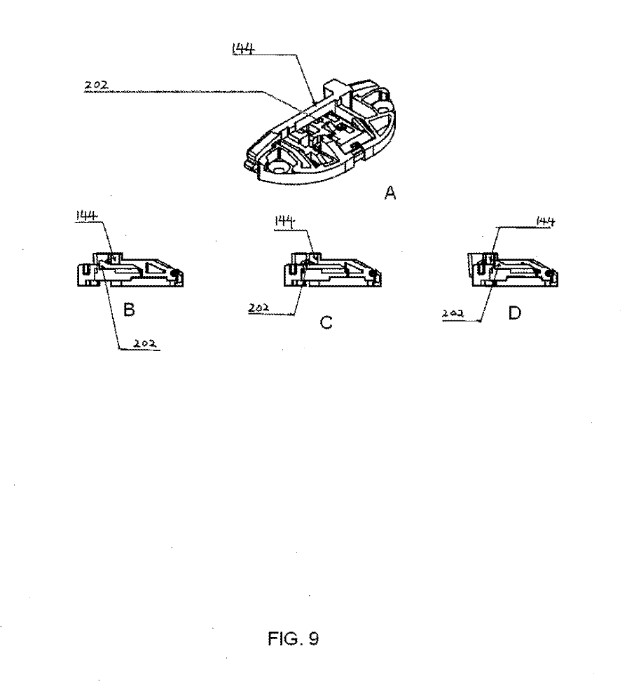

FIG. 9 A-D show a detailed process of assembling latch bolt 118 into base cover 116. Latch bolt 118 is positioned into base cover 116 from the front side of base cover 116 to the rear side of base cover 116 through latch bolt aperture 130. This process can be viewed in three steps. First, part of latch bolt 118 is pushed into base cover 116 with latch assembly limit 202 out of base cover 116 (shown in FIG. 9-B). Second, latch bolt 118 is further pushed into base cover 116 with latch assembly limit 202 is pressed downward by latch bolt aperture beam 144 (shown in FIG. 9-C). Third, latch bolt 118 is still further pushed into base cover 116 with latch assembly limit 202 in base cover 116 (shown in FIG. 9-D). In step three, latch assembly limit 202 pops up when it clears latch bolt aperture beam 144, and latch bolt aperture beam 144 confines latch assembly limit 202 and whereby confines latch bolt 118 in base cover 116. With limit device such as latch assembly limit 202, those skilled in the art will realize and understand, upon reading this description, that other and or different mechanisms may be used to fulfill this assembling process.

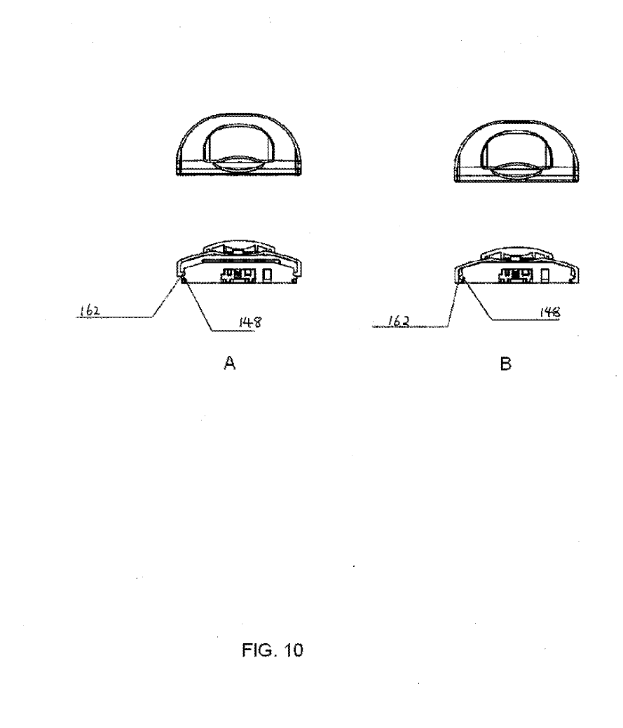

FIG. 10 A-B show a detailed process of mounting assembled top cover 212 to assembled base cover 210. This process can be viewed in two steps. First, assembled top cover 212 is mounted on assembled base cover 210 with each one of upper plugs 160 fitting into a separate one of bottom slots 146 and with each one of upper hooks 162 being resisted by a separate one of bottom hooks 148. This step leads to a so-called semi-assembly status. Second, assembled top cover 212 is further mounted on assembled base cover 210 with each one of upper plugs 160 fitting into a separate one of bottom slots 146 and also with each one of upper hooks 162 holding a separate one of bottom hooks 148. This step leads to a so-called final-assembly status. In the semi-assembly status, assembled top cover 212 can be disassembled from assembled base cover 210 easily. In the final-assembly, assembled top cover 212 snaps on assembled base cover 210, and it is relatively hard to disassemble the latch mechanism 100. With a double mounting mechanism such as the one discussed above, those skilled in the art will realize and understand, upon reading this description, that other and or different mechanisms may be used to fulfill this double mounting process.

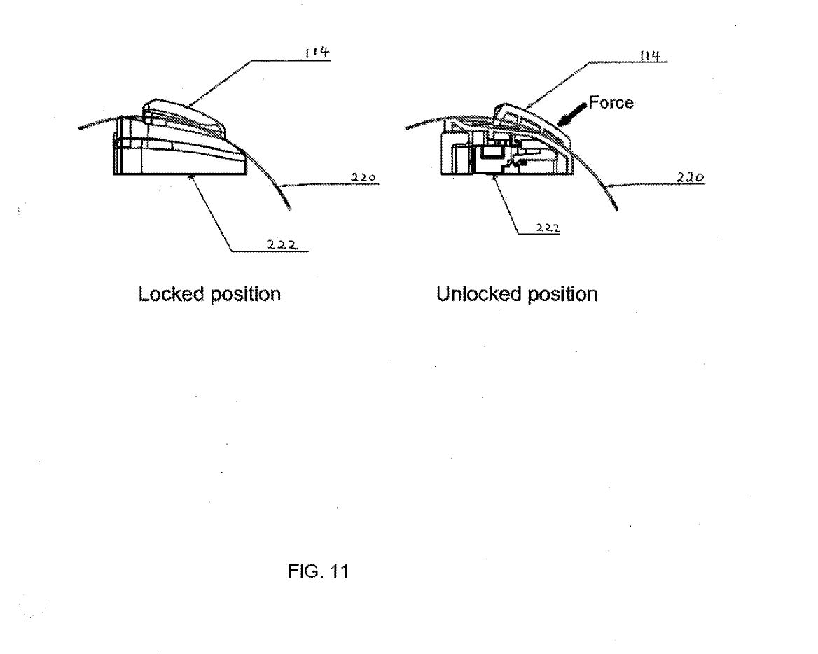

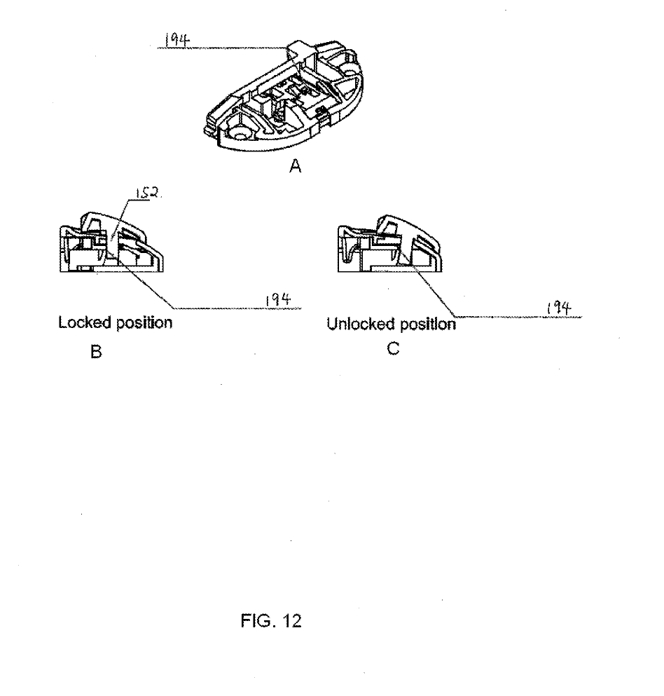

FIG. 11 shows the sliding track of trigger cap 114 on the arc side of top cover 112. During the operation of trigger cap 114, it slides along top cover meridian 220 to shift latch mechanism 100 between an extending (locked) position and a retracted (unlocked) position. Top cover meridian 220 is a curve whose projection on base surface 224 (shown in FIG. 3) is straight line 222. Straight line 222 parallels with the sliding orientation of latch bolt 118. FIG. 12 A-C show detailed circumstances of the locked position and unlocked position of latch mechanism 100. Latch bolt 118 has a pair of latch bolt slots 204, one of which has flexible tab 194. The bottom part of flexible tab 194 is connected to latch bolt 118. This gives flexible tab 194 resilience so that flexible tab 194 can define a variable room for one of latch bolt slots 204. Long cap shaft 152 extends into one of the latch bolt slots 204 with flexible tab 194. During the sliding process of trigger cap 114 from locked position and unlocked position, long cap shaft 152 is continuously pressed by flexible tab 194. This improves preferable contact between trigger cap 114 and latch bolt 118. With a flexible tab, those skilled in the art will realize and understand, upon reading this description, that other and or different mechanisms may be used to fulfill this curve sliding track and preferable contact. Since in the locked position, base stopping pin 180 (shown in FIG. 5) and latch stopping pin 196 (shown in FIG. 6) contacts with each other on their inclined surface, when a force is pushing trigger cap 114 toward front wall 134, latch stopping pin 196 is able to pass the limitation of base stopping pin 180 if the force is larger than the resistant force from base stopping pin 180. Therefore, latch bolt 118 can be actuated not only by actuator 120, but also by trigger cap 114 manually.

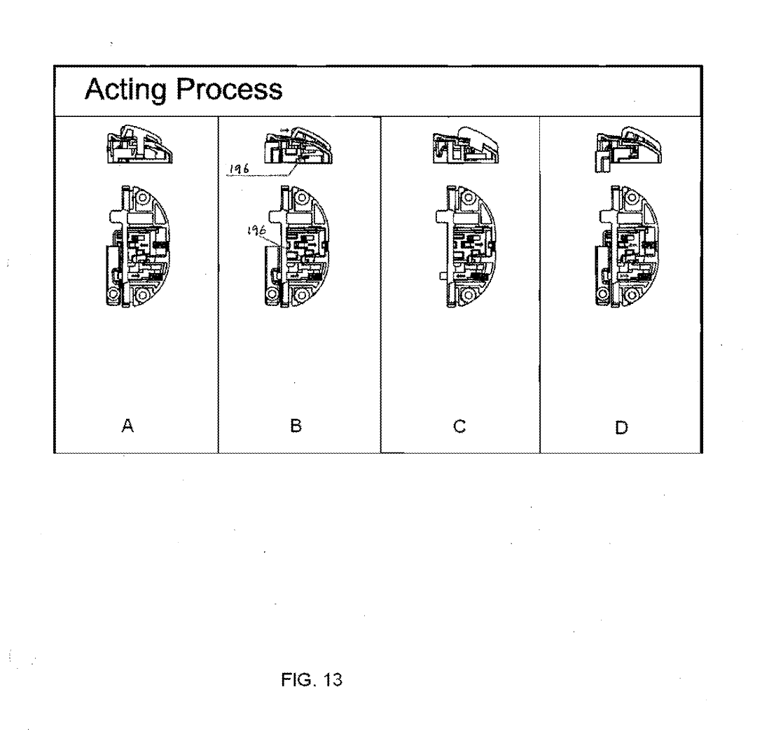

FIG. 13 A-D show an acting process of latch mechanism 100. FIG. 13 A depicts a locked position of latch mechanism 100. Latch bolt 118 extends out of housing 110 and is received by latch bolt receiver 125 on latch keeper 126. Actuator 120 is in a retracted position and resisted by bevel wall 128 (shown in FIG. 2) on latch keeper 126. One embodiment of latch mechanism 100 is applied on a double hung window. In the locked position for a hung window, latch hook 149 (shown in FIG. 2) is received by latch keeper socket 127 (shown in FIG. 2). FIG. 13 B depicts the action to an unlock position. By operating trigger cap 114, latch bolt 118 retracts into housing 110 and is kept into this position by latch stopping pin 196 engaged with base stopping pin 180. Before latch mechanism 100 moves away from latch keeper 126, actuator 120 is still in the retracted position. FIG. 13 C depicts the unlocked position. Latch bolt 118 is positioned in a position completely retracted in housing 110. Actuator 120, without limitation from bevel wall 128, extends outwardly from housing 110 under the pressure of actuator spring 124 (shown in FIG. 2). FIG. 13 D depicts the action to the locked position. After actuator 120 contacts bevel wall 128 on latch keeper 126, bevel wall 128 pushes actuator 120 into housing 110. Actuator 120 actuates and unlocks latch bolt 118 when actuator 120 is pushed into housing 110. Latch bolt 118 is unlocked by actuator 120 and extends out of housing 110 under the pressure of base spring 122 (shown in FIG. 2). Latch bolt 118 is received by latch bolt receiver 125. Latch mechanism 100 is in the locked position as before.

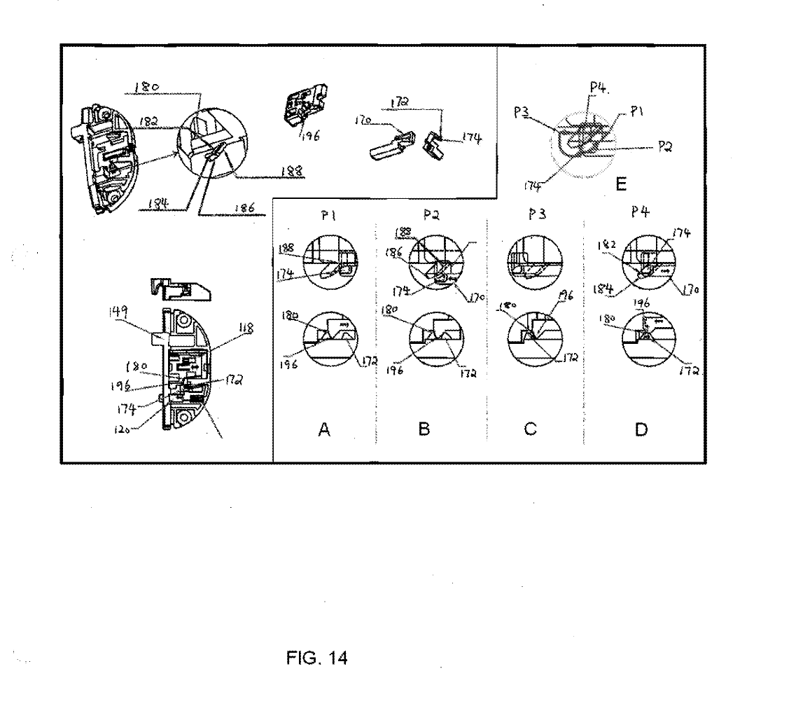

FIG. 14 A-E show a detailed actuating process. Contacting pin 174 of actuator 120 is moved along track P1-P2-P3-P4 (shown in FIG. 14 E). Track P1-P2-P3-P4 is a closed curve. Those skilled in the art will realize and understand, upon reading this description, that other and or different tracks or curves may be used to fulfill this actuating process. FIG. 14 A shows the actuating process in section P1, where actuator 120 is pressed by bevel wall 128 into housing 110 and latch bolt 118 is placed in the retracted position by operating trigger cap 114. Latch bolt 118 is limited to this position by latch stopping pin 196 engaged with base stopping pin 180. Contacting pin 174 is between base limit wall 188 and rear wall 138. This is the circumstance shown in FIG. 13 B. FIG. 14 B shows the actuating process in section P2, where latch bolt 118 is kept in its retracted position and actuator 120 is extending outwardly from housing 110 under the pressure of actuator spring 124. While actuator arm 170 moves forward, contacting pin 174 keeps touching base limit wall 188 and moves along base arc side 186, and therefore, actuating pin 172 circumvents latch trigger pin 198 (shown in FIG. 6). This is the circumstance shown in FIG. 13 C. FIG. 14 C shows the actuating process in section P3, where actuator 120 extends to a complete extending position. Contacting pin 174 passes base stud 184 and goes into harbor area 183 (shown in FIG. 5). FIG. 14 D shows the actuating process in section P4, where actuator 120 contacts bevel wall 128 on latch keeper 126 and bevel wall 128 pushes actuator 120 into housing 110 (also shown in FIG. 13 D). During this process, contacting pin 174 slides backward along base chamfer 182, wherein actuating pin 172 lifts latch trigger pin 198, which disengages latch stopping pin 196 from base stopping pin 180. Latch bolt 118, without the limitation from base stopping pin 180, extends outwardly from housing 110 under the pressure of base spring 122. Base chamfer 182, base stud 184, base arc side 186, and base limit wall 188 constitute a sliding ridge defining the sliding track (a closed curve) for contacting pin 174. Those skilled in the art will realize and understand, upon reading this description, that other and or different sliding ridges may be used to fulfill this actuating process. Those skilled in the art will also realize and understand, upon reading this description, that other and or different mechanisms may be used to fulfill this actuating process.

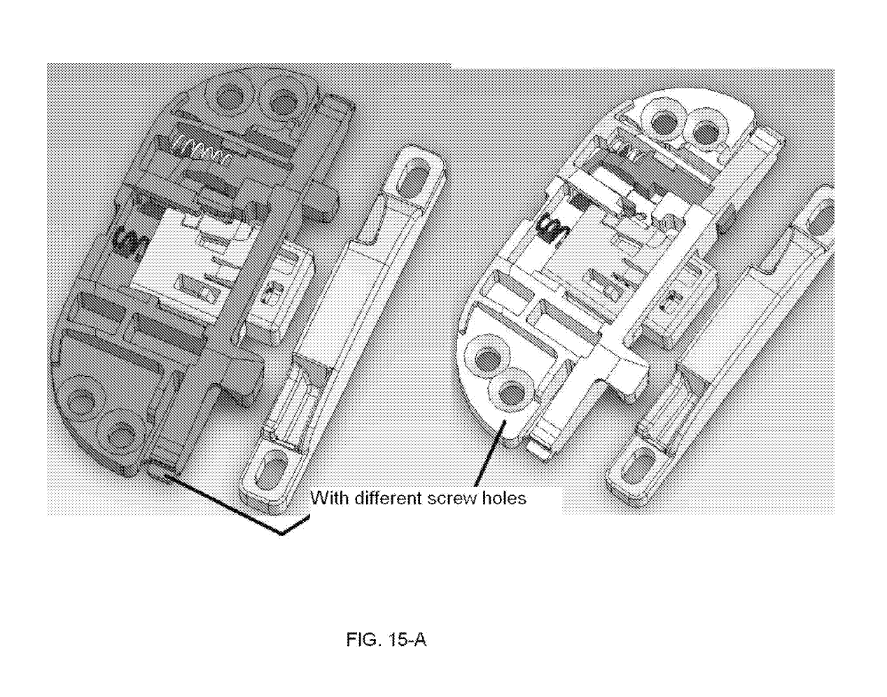

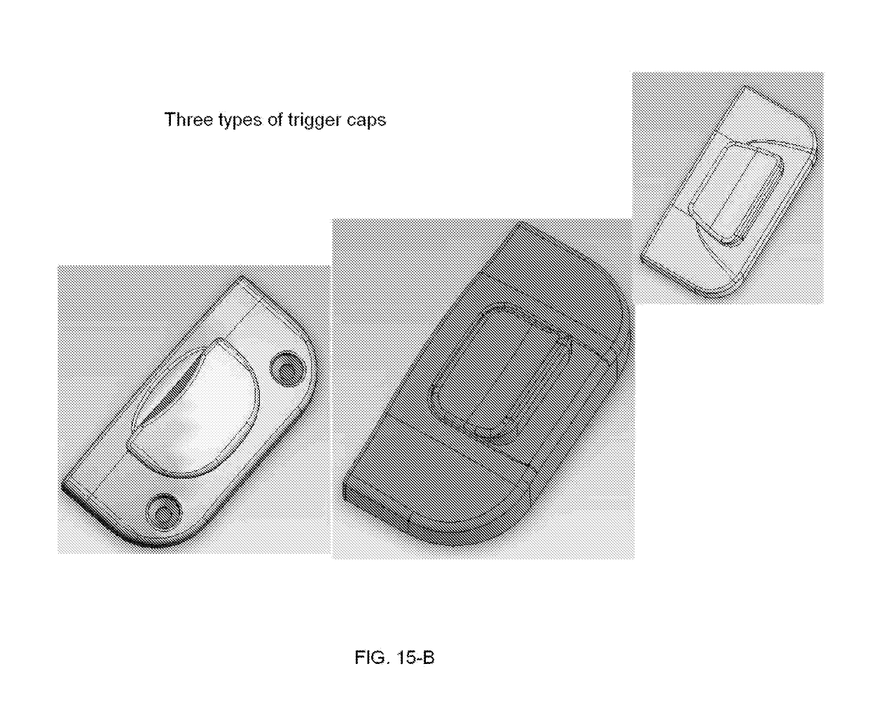

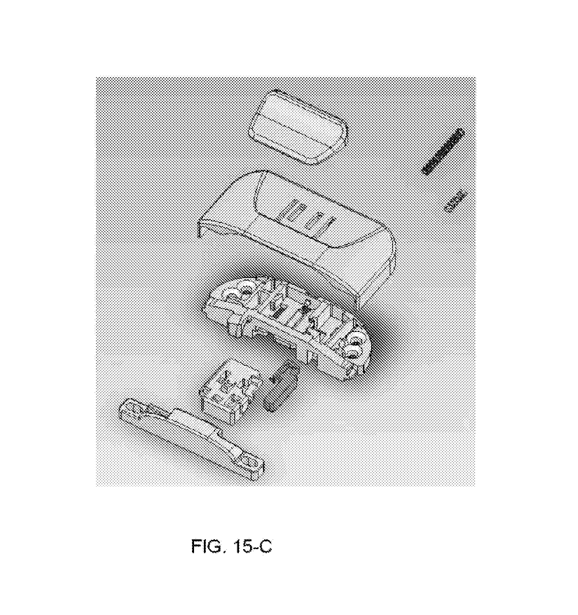

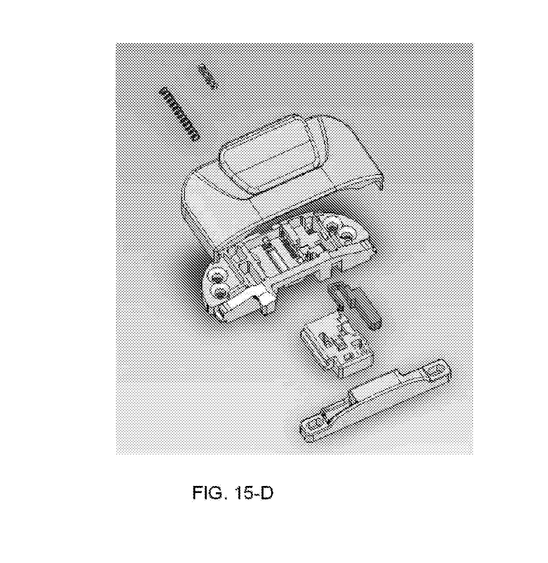

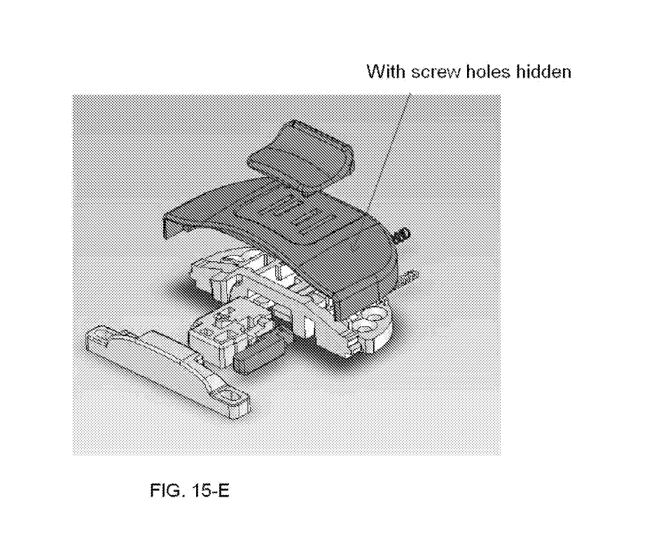

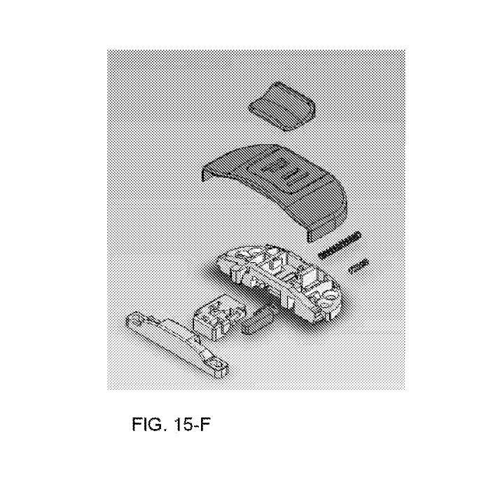

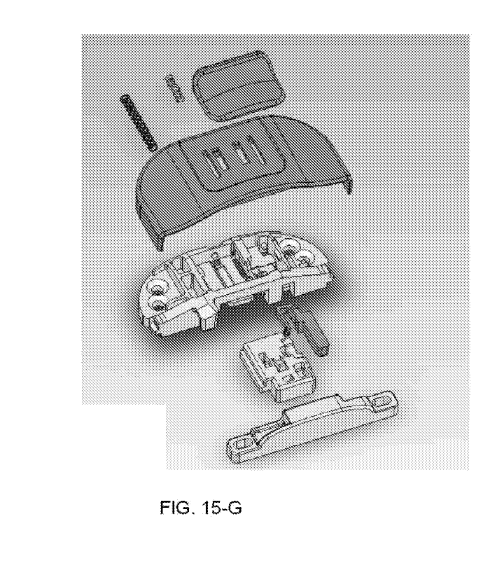

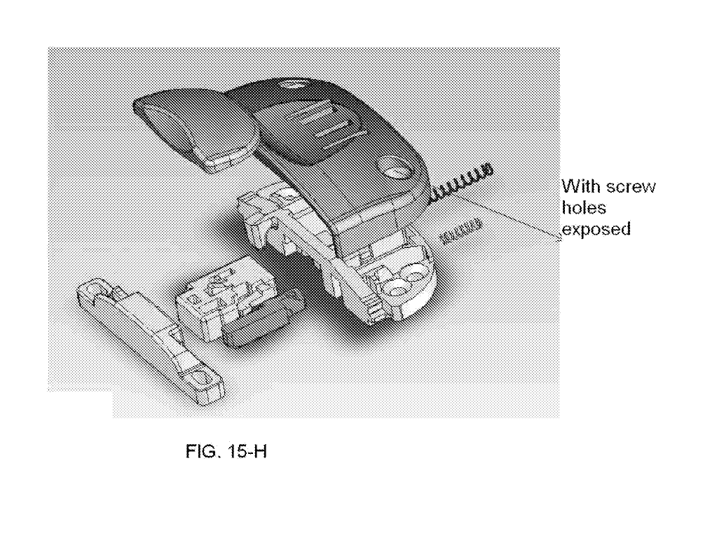

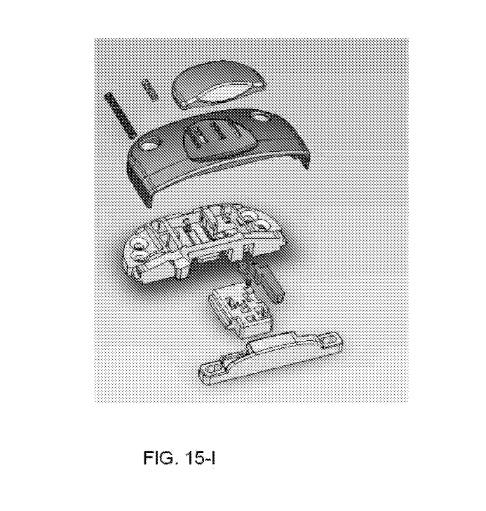

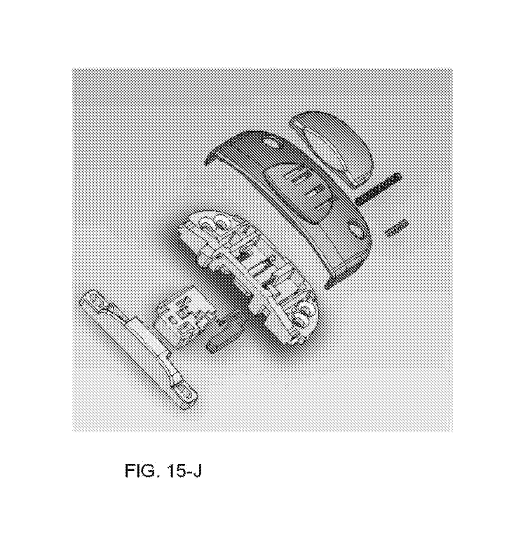

FIG. 15 A-J show different embodiments with various trigger caps and screw holes. The latch mechanism disclosed here can be equipped with various trigger caps. FIG. 15 B gives three exemplary trigger caps. FIG. 15 C-D show the assembly of the latch mechanism with the first kind trigger cap. FIG. 15 E-G show the assembly of the latch mechanism with the second kind trigger cap. FIG. 15 H-J show the assembly of the latch mechanism with the third kind trigger cap. Those skilled in the art will also realize and understand, upon reading this description, that other and or different trigger caps may be used.

The latch mechanism disclosed here can be attached to sashes in various approaches with different screw locations. For example, FIG. 15 H-J show one type of screw locations, where the screw holes are exposed on the housing of the latch mechanism. FIG. 15 C-G show other types of screw locations, where the screw holes are on the base cover of the latch mechanism. These holes are hidden by the top cover and cannot be seen when the latch mechanism is assembled.

FIG. 15 A shows two different types of screw locations on the base cover. Multiple screw locations increase the adaptability of this latch mechanism to many window systems, including but not limited to, sliding window systems and double-hung window systems. Those skilled in the art will also realize and understand, upon reading this description, that other and or different screw locations may be used to adapt this latch mechanism to various window systems.

What is claimed is:

1. A latch mechanism for a window comprising:
a housing defining an opening therein;
a latch bolt slidably disposed in the housing and selectively positionable between an extended position and a retracted position, wherein such latch bolt is adapted to be actuated by an actuator from the retracted position to the extended position;
a sliding ridge on the inside surface of the housing;
a stopping mechanism adapted to automatically engage and retain the latch bolt in the retracted position as the latch bolt is positioned from the extended to the retracted position; and
an actuator including a sliding contactor adapted to slide along a closed curve defined by the sliding ridge, wherein the actuator is arranged to extend outwardly from the housing without actuating the latch bolt as the sliding contactor goes along one section of the closed curve, and to retract inwardly to the housing and actuate the latch bolt as the sliding contractor goes along the other section of the closed curve.

2. The latch mechanism in accordance with claim 1, wherein the actuator further comprises a resilient element adapted to cause the actuator to extend outwardly from the housing.

3. The latch mechanism in accordance with claim 2, wherein the resilient element includes an actuator spring.

4. The latch mechanism in accordance with claim 1, wherein the actuator further comprises an actuating pin adapted to actuate the latch bolt.

5. The latch mechanism in accordance with claim 1, wherein the stopping mechanism includes a latch stopping pin on the latch bolt adapted to engage with a base stopping pin on the surface of the housing.

6. The latch mechanism in accordance with claim 5, wherein the latch stopping pin is adapted to be actuated by an actuating pin on the actuator.

7. The latch mechanism in accordance with claim 1, wherein the sliding ridge comprises a base chamfer, a base stud, a base arc side, and a base limit wall.

8. A latch mechanism in accordance with claim 1, wherein the housing further comprising a top cover and a bottom cover; wherein the actuator further comprises a resilient element adapted to cause the actuator to extend outwardly from the housing; wherein the actuator further comprises an actuating pin adapted to actuate the latch bolt; wherein the stopping mechanism includes a latch stopping pin on the latch bolt adapted to engage with a base stopping pin on the surface of the housing; and wherein the latch stopping pin is adapted to be actuated by the actuator.

9. A latch mechanism in accordance with claim 1, wherein the latch mechanism can be adapted to double hung window.

10. A latch mechanism in accordance with claim 1, wherein the latch mechanism can be adapted to sliding sash window.

11. A lock mechanism for a window comprising:
a latch mechanism comprising:
a housing defining an opening therein;
a latch bolt slidably disposed in the housing and selectively positionable between an extended position and a retracted position, wherein such latch bolt is adapted to be actuated by an actuator from the retracted position to the extended position;
a sliding ridge on the inside surface of the housing;
a stopping mechanism adapted to automatically engage and retain the latch bolt in the retracted position as the latch bolt is positioned from the extended to the retracted position; and
an actuator including a sliding contactor adapted to slide along a closed curve defined by the sliding ridge, wherein the actuator is arranged to extend outwardly from the housing without actuating the latch bolt as the sliding contactor goes along one section of the closed curve, and to retract inwardly to the housing and actuate the latch bolt as the sliding contractor goes along the other section of the closed curve; and
a latch keeper adapted to receive the latch bolt as the latch bolt is in the extended position, wherein the latch keeper comprises a bevel wall adapted to push the actuator inwardly to the housing and confine the actuator to the actuator's retracted position as the latch keeper receives the latch bolt.

12. A latch mechanism for a window comprising:
a housing defining an opening therein, wherein such housing has a top cover with an arc side;
a latch bolt slidably disposed in the housing and adapted to contact a trigger cap and to move between an extended position and a retracted position; and
a trigger cap that is slidably disposed on the arc side of the top cover of the housing;
wherein the trigger cap is adapted to slide along a meridian of the arc side of the top cover; wherein the projection of the meridian on the base surface of the housing parallels the moving orientation of the latch bolt.

13. A latch mechanism in accordance with claim 12, wherein the trigger cap further comprises a cap shaft adapted to extend into a latch bolt slot on the latch bolt.

14. The latch mechanism in accordance with claim 13, wherein the latch bolt slot on the latch bolt contacts with a flexible tab adapted to reduce the contacting space between the cap shaft and the latch bolt slot in the sliding process of the trigger cap.

15. A latch mechanism in accordance with claim 12, wherein the trigger cap further comprises two shafts adapted to extend into two latch bolt slots on the latch bolt, wherein one of the two latch bolt slots on the latch bolt has a flexible tab adapted to reduce the contacting space between that latch bolt slot and the shaft extending into that latch bolt slot in the sliding process of the trigger cap.

16. A latch mechanism in accordance with claim 14, wherein one of the two cap shafts is longer than the other one, and wherein the longer cap shaft is adapted to extend into the latch bolt slot having the flexible tab.

17. A latch mechanism for a window comprising:
a housing defining an opening therein;
a latch bolt slidably disposed in the housing and adapted to move between an extended position and a retracted position;
a stopping mechanism adapted to automatically engage and retain the latch bolt in the retracted position as the latch bolt is positioned from the extended to the retracted position; and
a trigger cap that is slidably disposed on a surface of the housing; wherein the trigger cap is adapted to slide along the surface with the movement of the latch bolt; and wherein the trigger cap is adapted to release the latch bolt from the retracted position as the stopping mechanism engages the latch bolt.

18. A latch mechanism in accordance with claim 17, wherein the latch mechanism further comprises a resilient element adapted to cause the latch bolt to extend outwardly from the housing.

19. A latch mechanism in accordance with claim 18, wherein the resilient element is a spring.

20. A latch mechanism in accordance with claim 17, wherein the stopping mechanism comprises a latch stopping pin on the latch bolt adapted to engage with a base stopping pin on the surface of the housing.

21. A latch mechanism for a window comprising:
a housing defining an opening therein;
a latch bolt slidably disposed in the housing and adapted to be installed in the housing through the opening and to move between a predetermined extended position defined by a confining element and a retracted position;
a resilient element adapted to push the latch bolt form the retracted position to the predetermined extended position; and
a confining element on the latch bolt, wherein such confining element is adapted to goes through the opening into the housing with a part of the latch bolt and to prevent the latch bolt from being pushed outward beyond the predetermined extended position defined by the confining element.

22. A latch mechanism in accordance with claim 21, wherein the resilient element is a spring.

23. A latch mechanism in accordance with claim 21, wherein the confining element is a latch assembly limit adapted to be pushed into the latch bolt by the latch bolt aperture beam of the opening as the latch bolt is installed in the housing through the opening and to resume and be confined in the housing by the latch bolt aperture beam of the opening.

24. A latch mechanism for a window comprising:
a housing includes a top cover and a base cover;
a latch bolt slidably disposed in the housing and adapted to be to move between an extended position and a retracted position;
a hook mechanism coupled with the top cover and the base cover; wherein such hook mechanism is adapted to hold the top cover and the base cover together when a plug-socket mechanism holds the top cover and the base cover together; and
a plug-socket mechanism coupled with the top cover and the base cover; wherein such plug-socket mechanism is adapted to hold the top cover and the base cover together when the hook mechanism does not hold the top cover and the base cover together.

25. A latch mechanism in accordance with claim 24, wherein the hook mechanism comprises a pair of upper hooks and a pair of bottom hooks, and wherein the upper hooks are adapted to snap on the bottom hooks.

26. A latch mechanism in accordance with claim 24, wherein the plug-socket mechanism comprises a pair of upper plugs and a pair of bottom slots, and wherein the upper plugs are adapted to plug into the bottom slots part.

27. A latch mechanism in accordance with claim 24, wherein the hook mechanism comprises a pair of upper hooks and a pair of bottom hooks, and wherein the upper hooks are adapted to clasp with the bottom hooks; wherein the plug-socket mechanism comprises a pair of upper plugs and a pair of bottom slots, and wherein the upper plugs are adapted to plug into the bottom slots part.
